(19) United States
(12) Patent Application Publication
(10) Pub. No.: US 2004/0107266 A1
(43) Pub. Date: Jun. 3, 2004

(54) URL management system and URL management server

(75) Inventors: Toshifumi Tanaka, Tokyo (JP); Yoshiharu Ito, Tokyo (JP); Takashi Namioka, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Chuo-ku (JP)

(21) Appl. No.: 10/400,150

(22) Filed: Mar. 25, 2003

(30) Foreign Application Priority Data
Mar. 25, 2002 (JP) 2002-083071

(51) Int. Cl. G06F 15/16

(52) U.S. Cl. 709/217

(57) ABSTRACT

This invention provides a URL management system and URL management server that is able to reduce the inconvenience that arises when the URL of a web site is changed. The system comprises a web site server 20 containing the content of a web site, a URL management server 30 that associates the URL of the web site with an intermediate URL corresponding thereto and a search server 40 that associates information regarding the content of the web site with the intermediate URL. The search server 40 sends out the intermediate URL in response to a request from a search based on the information, and the URL management server 30 converts the access destination to the URL of the web site in response to an access request made using the intermediate URL. Thereby, even in the case in which the URL of a web site is changed, there is no need to change the content registered in each search engine.

### BACKGROUND OF THE INVENTION

The present invention relates to a Uniform Resource Locator (URL) management system, and particularly to a URL management system and URL management server that is able to reduce the inconvenience that arises when the URL of a web site is changed.

### DESCRIPTION OF THE PRIOR ART

With the remarkable spread of the Internet in recent years, many people are now using it. In addition, it is not usual for users to not merely view web sites on the Internet, but also create their own web sites and make them available to the public on the Internet. With this spread of the Internet, many companies are using the Internet as an advertising medium, as an online store for selling the company's products or the like or as a customer service site or the like.

Since it is preferable for such corporate web sites to be viewed by a large number of consumers, it is possible to perform the so-called “registration” of web sites with search engines and make the presence of one's corporate web site known to even more consumers thereby promoting access. Accordingly, in order to get more page views, it is preferable that a web site be registered on even more search engines. Here, this registration with search engines typically involves providing the URL of one's corporate web site, keywords for searching and introductory text that briefly introduces the content of the web site. The user/consumer first accesses the search engine and uses keywords to search for registered web sites and then accesses the web sites that come up as hits using the URLs provided, and thus the web sites in question can be viewed.

Accordingly, by performing this registration with search engines, the company providing the web site can advertise the keywords registered with search engines in newspapers, magazines, television or other media and thus get more page views by consumers.

However, the URLs of web sites are often changed due to server migration or the like, and due to various circumstances on the part of the web site provider. In such a case, there is a problem in that the web site provider changing a URL must change the content of the registration on all of the search engines where the web site is registered, so this takes a considerable amount of time and effort.

The same applies to the provider of the search engine, as each time a URL is changed there is a request from the web site provider to change the content of the registration, so there is a problem in this requires a large amount of labor in this management.

Moreover, until the work of changing the content of registration with the search engine is complete, a consumer who wishes to access the web site in question cannot view the desired web site despite using the URL of the web site that appears as a search hit. In this case, as described above, the amount of labor required of the web site provider and search engine provider accompanying a change of URL is large, so there are cases in which the time until the desired web site can be viewed may be a relatively long time, so there is a problem in that this is inconvenient to the consumers attempting to access the web site in question. This same problem occurs when the old URL is registered by a bookmark in a browser.

The above describes an example wherein the provider of a web site is a company, but the problem described above is not limited to the case in which the web site provider is a company, but rather the same problem occurs in the case of an individual.

### SUMMARY OF THE INVENTION

Accordingly, an object of the present invention is to provide a URL management system and URL management server that is able to reduce the inconvenience that arises when the URL of a web site is changed.

This object of the present invention is achieved by a URL management system comprising: a web site server containing the content of a web site, a URL management server that associates the URL of the web site with an intermediate URL corresponding thereto and a search server that associates information regarding the content of the web site with the intermediate URL.

In a preferred embodiment of the present invention, the search server sends out the intermediate URL in response to a request from a search based on the information, and the URL management server converts the access destination to the URL of the web site in response to an access request made using the intermediate URL.

In a further preferred embodiment of the present invention, in response to receiving notification of a change in the URL of the web site, the URL management server does not change the intermediate URL but rather associates the new URL of the web site with the intermediate URL.

The object of the present invention is also achieved by a URL management server comprising: means of generating an intermediate URL corresponding to the URL of a stipulated web site upon receiving information regarding the content of the stipulated web site and the URL of the stipulated web site, means of storing the URL of the stipulated web site associated with the intermediate URL and means of sending out information regarding the content of the stipulated web site and the intermediate URL to the search server.

In a preferred embodiment of the present invention, the means of generating an intermediate URL generates the intermediate URL by replacing the portion that identifies the server name within the URL of the stipulated web site with the server name of the URL management server.

The object of the present invention is also achieved by a URL management server comprising: a URL management table that associates the URLs of a plurality of web sites with a plurality of intermediate URLs, wherein, in response to an access request made using a stipulated intermediate URL, a lookup of the URL management table is performed and the URL of the corresponding web site is read out, and the access is performed using the web site URL thus read out.

In a preferred embodiment of the present invention, in response to receiving notification of a change in the URLs of the plurality of web sites, the intermediate URL is not changed but rather the URL of the stipulated web site registered in the URL management table is updated.

With the present invention having the aforementioned constitution, even in the case in which the URL of a web site is changed, there is no need to change the content registered in each search engine, so it is possible to greatly reduce the labor required on the part of the web site provider and search engine provider accompanying the URL change.

The above and other objects and characteristics of the present invention will become apparent based on the following description and corresponding drawings.

### BRIEF DESCRIPTION OF THE DRAWINGS

FIG. 1 is a schematic diagram of the configuration of a URL management system according to a preferred embodiment of the present invention.

FIG. 2 is a schematic block diagram showing a specific configuration of the URL management server 30.

FIG. 3 is a sequence diagram used to describe the functions of the URL management system.

FIG. 4 is a flowchart illustrating the URL management operation in the case of receiving a registration request.

FIG. 5 is a schematic diagram illustrating the structure of the URL management table 32b.

FIG. 6 is a flowchart illustrating the URL management operation in the case of receiving an access using an intermediate URL.

FIG. 7 is a schematic diagram illustrating the state in which the web site provider changes the location where the web site is stored from web site server 20 to web site server 21.

FIG. 8 is a flowchart illustrating the URL management operation in the case of receiving notification of a change in the original URL.

### DESCRIPTION OF THE PREFERRED EMBODIMENTS

Here follows a detailed description of a preferred embodiment of the present invention made with reference to the appended drawings.

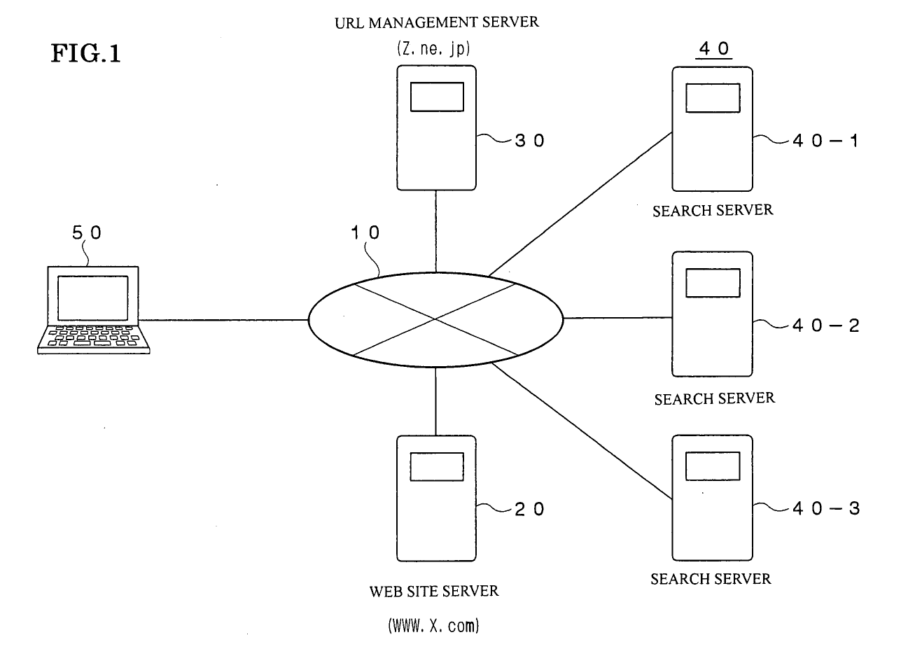

FIG. 1 is a schematic diagram of the configuration of a URL management system according to a preferred embodiment of the present invention.

As shown in FIG. 1, the URL management system according to this embodiment consists of a web site server 20, URL management server 30 and a plurality of search servers 40 (40-1, 40-2 and 40-3), which are connected to each other via the Internet 10. The web site server 20 is a server that contains the web site contents. While this is no particular limitation, in the case that the web site provider is a company, this web site may be used to advertise the company's products or the like, or it may be used as an online store for selling the company's products or the like or as a customer service site or the like. The URL management server 30 is most characteristic of the present invention, so here follows a description of its configuration and significance. Each of the plurality of search servers 40 (40-1, 40-2 and 40-3) houses a different search engine, and these search engines are managed by the search engine providers.

While this is described in detail below, in this embodiment, the registration of web sites with search engines is not performed by the web site provider directly to the search engine provider, but rather it is performed indirectly via the URL management server 30. To wit, a search engine registration request is issued from the web site server 20 to the URL management server 30, and based on a URL management program, the URL management server 30 makes the actual requests for registration with search engines to the search servers 40.

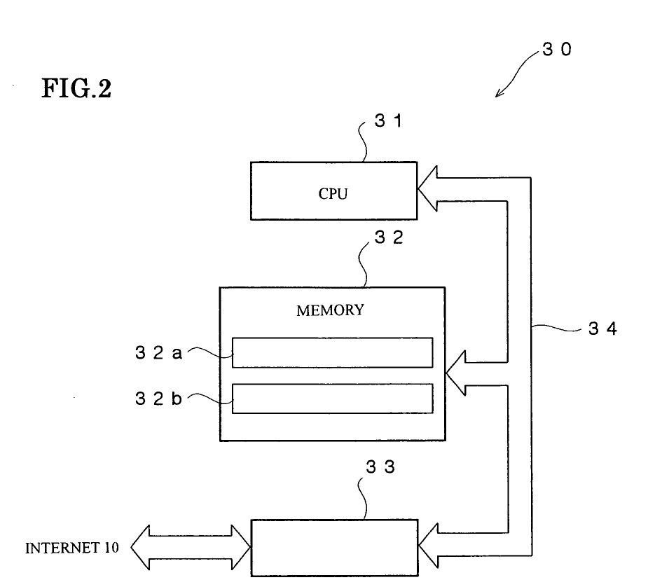

FIG. 2 is a schematic block diagram showing a specific configuration of the URL management server 30.

As shown in FIG. 2, the URL management server 30 consists of a CPU 31, memory 32 and interface block 33, which are connected to each other by a bus 34. The memory 32 contains at least a URL management program 32a and a URL management table 32b, and by executing this URL management program 32a with the CPU 31, the URL management server 30 is able to perform the URL management operations using the URL management table 32b. Details of the URL management operations will be described later.

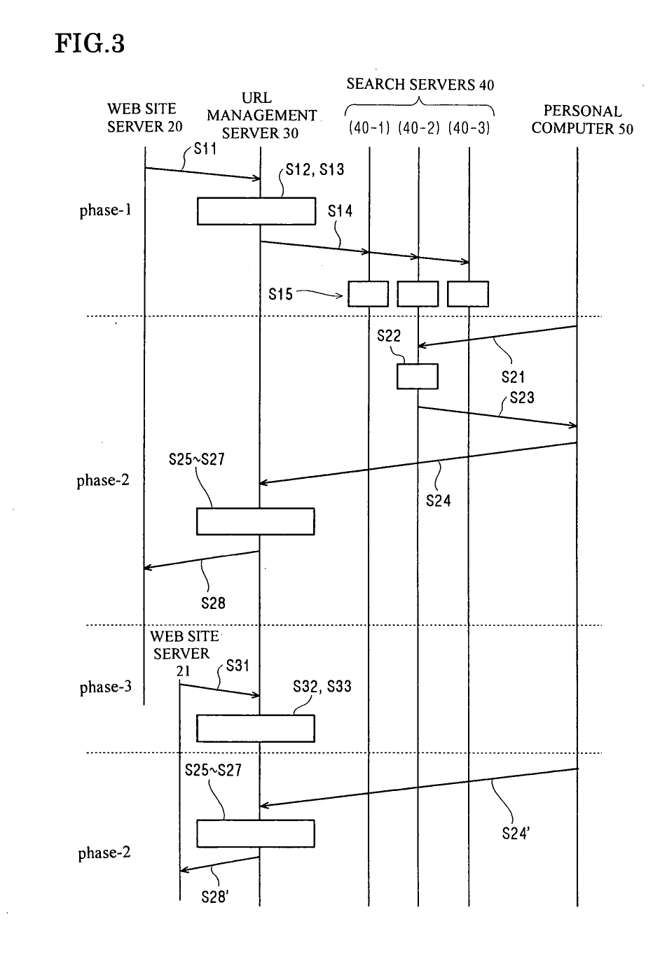

FIG. 3 is a sequence diagram used to describe the functions of this URL management system in this embodiment.

The functions of this URL management system in this embodiment are divided into a phase of registration with search engines (phase-1), a phase of a user (consumer) accessing the web site (phase-2) and a phase of changing the URL of the web site (phase-3), and these phases involve URL management operations performed by the URL management server 30. Here follows a description of these phases in order.

We shall first describe the phase of registration with search engines (phase-1).

When registering with a search engine, the provider of the web site to be registered with a search engine makes a search engine registration request to the URL management server 30 (Step S11). This registration request can be performed by sending the URL of the web site, the search engines subject to registration, keywords used for searching, and an introductory text that briefly introduces the content of the web site from the web site server 20 via the Internet 10 to the URL management server 30. Here, we shall proceed with the description assuming that the URL of the web site is:

http://www.X.com/A/present/,

the search engines subject to registration are the search engines within all of the search servers 40 (40-1, 40-2 and 40-3) shown in FIG. 1, the keywords are “A present” and the introductory text is “Company A's present contest entry page.”

Upon receiving such a registration request via the interface block 33, the URL management server 30 performs the following URL management operation #1 according to the URL management program 32a contained in memory 32.

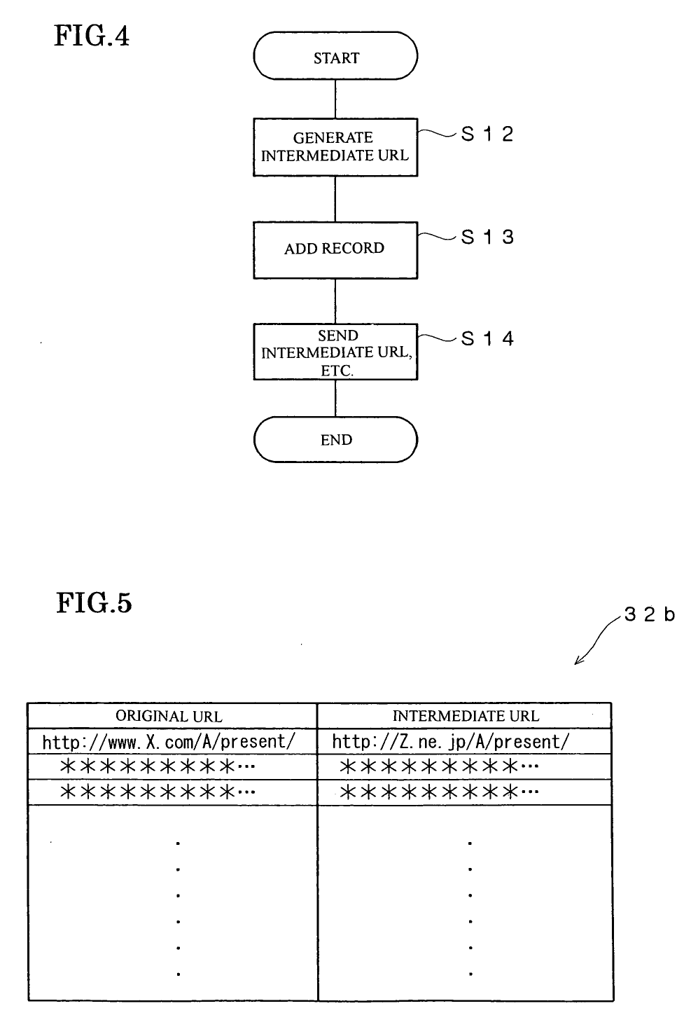

FIG. 4 is a flowchart illustrating URL management operation #1 in the case of receiving a registration request.

As shown in FIG. 4, upon receiving a registration request from the web site server 20, according to the URL management program 32a, the CPU 31 within the URL management server 30 generates an intermediate URL wherein the server name is the URL management server 30 (Step S12) and adds a record consisting of the URL of the web site and the intermediate URL thus generated to the URL management table 32b, thereby associating the URL of the web site with the intermediate URL thus generated. While this is no particular limitation, it is preferable that the intermediate URL be generated such that the server name identifies the URL management server 30, but within the URL of the web site, only the portion that identifies the server name is replaced with the server name of the URL management server 30.

Accordingly, if the server name of the URL management server 30 is:

Z.ne.jp

then the intermediate URL thus generated may be made:

http://Z.ne.jp/A/present/

for example.

FIG. 5 is a schematic diagram illustrating the structure of the URL management table 32b.

As shown in FIG. 5, the URL management table 32b stored in memory 32 consists of a plurality of records, each consisting of the URL of a web site subject to registration (called the “original URL”) and the corresponding intermediate URL, so the original URLs and intermediate URLs are thus associated.

Next, according to the URL management program 32a, the CPU 31 of the URL management server 30 sends the intermediate URL, keywords and introductory text to the search servers 40 that contain the search engines with which the site is to be registered (Step S14). Accordingly, in the example described above, the sending from the URL management server 30 is done to all of the search servers 40 (40-1, 40-2 and 40-3) shown in FIG. 1, and the intermediate URL sent is:

http://Z.ne.jp/A/present/,

the keywords are “A present” and the introductory text is “Company A's present contest entry page.”

Moreover, based on the URL, keywords and the like received from the URL management server 30, the administrators of the search servers 40 perform the actual registration with the respective search engines (Step S15). This completes the phase of registration with search engines (phase-1).

We shall now describe the phase of a user (consumer) accessing the web site (phase-2).

After the phase of registering with search engines described above is complete, when a user (consumer) uses a personal computer 50 connected to the Internet 10 to access one of the stipulated search servers 40 (in the example shown in FIG. 3, search server 40-2) (Step S21), and performs a stipulated keyword search using that search engine (Step S22), a number of web sites registered with the search engine will appear as hits and these results are sent to the personal computer 50 (Step S23). Accordingly, if the user performs a search with “A present” as the keywords, a hit on the web site within web site server 20 occurs and the corresponding URL and introductory text will be displayed on the display of the personal computer 50. In this case, the URL registered with the search engine is the intermediate URL so the intermediate URL described above is displayed on the personal computer 50 as the URL of the web site in question.

Accordingly, the intermediate URL displayed on the personal computer 50 is:

http://Z.ne.jp/A/present/

and if this is used to make an access request, naturally this will be an access with respect to the URL management server 30 (Step S24). Upon receiving such an access, the URL management server 30 will perform URL management operation #2 described below according to the URL management program 32a stored in memory 32.

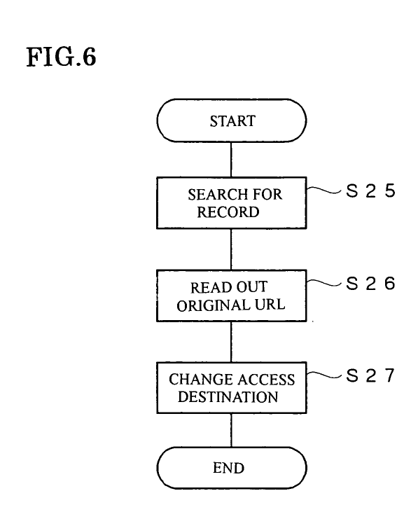

FIG. 6 is a flowchart illustrating URL management operation #2 in the case of an access request made using an intermediate URL.

When access is requested using an intermediate URL via the interface block 33, as shown in FIG. 6, according to the URL management program 32a, the CPU 31 of the URL management server 30 searches through the URL management table 32b for a record containing this URL as the intermediate URL (Step S25). Then, the original URL of the record thus found is read out (Step S26), and the destination of the access from the personal computer 50 is changed to the original URL thus read out (Step S27).

Accordingly, if an access request from the personal computer 50 is made using the address:

http://Z.ne.jp/A/present/,

then based on the lookup of the URL management table 32b, the corresponding original URL of:

http://www.X.com/A/present/

is read out and the destination of the access is changed to this.

An access is thus made to the web site server 20, so the user can view the desired web site (Step S28). Here, the conversion from intermediate URL to original URL is executed automatically by the URL management server 30 according to the URL management program 32a, so the user can view the desired web site without being aware of the presence of the URL management server 30. This completes the phase of a user (consumer) accessing the web site (phase-2).

We shall now describe the phase of changing the URL of the web site (phase-3).

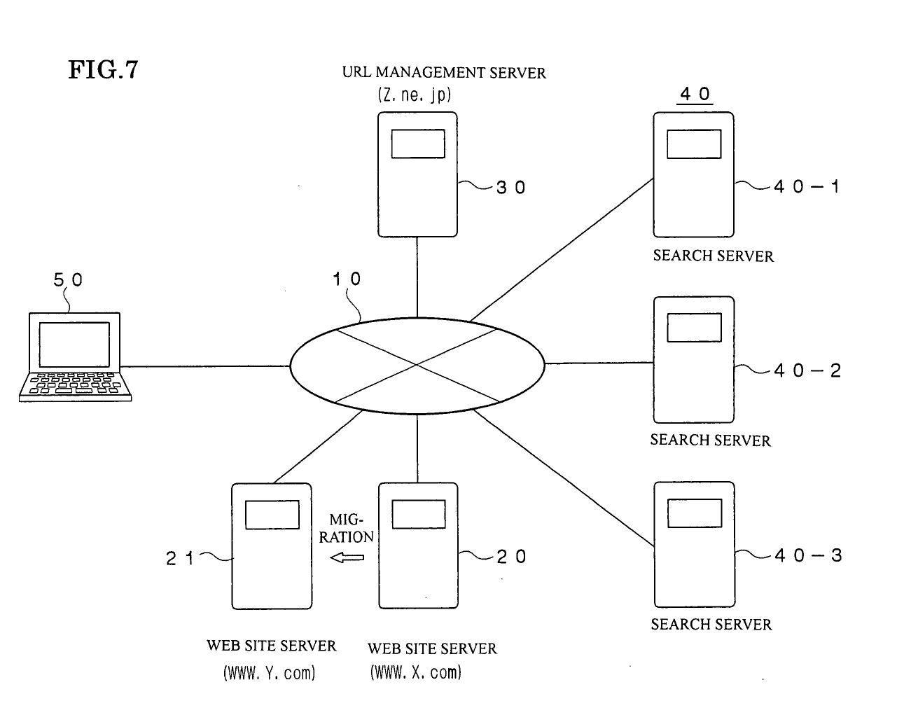

First, as shown in FIG. 7, when the web site provider migrates the storage location of the web site from web site server 20 to web site server 21, this changes the URL of the web site in question, so the web site provider notifies the URL management server 30 of this fact and the new URL (Step S31). To wit, this is a notification of a change in the original URL. This notification can be performed by sending the new URL and old URL of the web site from the web site server 21 to the URL management server 30. Here, we shall proceed with the description using the case in which the new URL (original URL) is changed from:

http://www.X.com/A/present/

to

http://www.Y.com/A/present/

as an example. Upon receiving this notification, the URL management server 30 performs the following URL management operation #3 according to the URL management program 32a stored in memory 32.

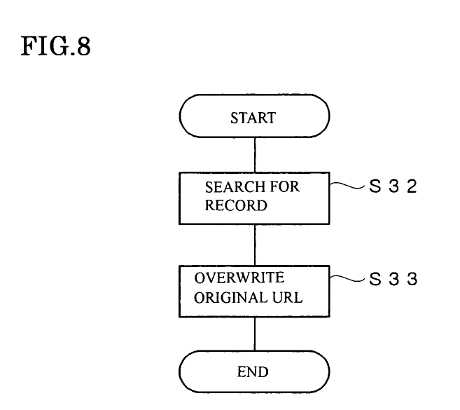

FIG. 8 is a flowchart illustrating URL management operation #3 in the case of receiving notification of a change in the original URL.

As shown in FIG. 8, upon receiving notification of a change in the original URL via the interface block 33, according to the URL management program 32a, the CPU 31 within URL management server 30 searches for a record within the URL management table 32b that has the old URL contained in the change notification registered as the original URL (Step S32) and overwrites the original URL in the record thus found with the new URL contained in the change notification (Step S33).

Thereby, the original URL corresponding to the intermediate URL is changed from

http://www.X.com/A/present/

to

http://www.Y.com/A/present/.

This completes the phase of changing the URL of the web site (phase-3). To wit, it is sufficient for a web site provider who changes the URL of a web site to merely issue a change notification to the URL management server 30, so there is no need to change the content of registration with the search engine. On the other hand, once the phase of changing the URL of the web site (phase-3) is complete, when a user uses a URL obtained by a keyword search using a search engine to perform an access (Step S24′), it is possible to correctly access the web site within web site server 21 without being aware of the change in the original URL (Step S28′).

As described above, with this embodiment, the intermediate URL rather than the original URL is registered with search engines, so when access is done using the intermediate URL, the URL management server 30 converts this access to an access to the original URL, so a web site provider who has changed an URL need not change the registered content on those search engines with which the site is registered, thus greatly reducing the labor involved in changing a URL. In addition, with this embodiment, the web site provider does not request that the provider of a search engine change the content of registration when a URL is changed, so the burden of management is greatly lessened on the part of the search engine provider. Moreover, with this embodiment, the URL change procedure is simplified so it is possible to effectively prevent situations wherein a web site cannot be accessed due to a URL change.

Accordingly, if the provider of a web site is a company and the web site is used in-house or for advertisements of the company's products and the like, or used as an online store for the company's products or as a customer support site or the like, it is possible to advertise the keywords registered with search engines in newspapers, magazines, television or other media, but even if the URL of the web site is changed, there is no need to change the advertisements used in newspapers, magazines, television or other media, and still get more page views by consumers.

The present invention is in no way limited to the aforementioned embodiments, but rather various modifications are possible within the scope of the invention as recited in the claims, and naturally these modifications are included within the scope of the invention.

For example, in the Embodiment described above, the case in which there was one URL management server 30 was described as an example, but there is no need for there to be only one URL management server 30, but rather a plurality of these may be disposed around the Internet and it is preferable that the URL management tables 32b contained in these URL management servers 30 be synchronized.

In addition, within the present invention, a “means” need not necessarily refer to a physical means but rather it also includes the case in which the functions of the various means are implemented in software. Moreover, the functions of one means may be implemented by two or more physical means, or the functions of two or more means may be implemented by one physical means.

As described above, with the present invention, it is possibly to greatly reduce the inconvenience arising when the URL of a web site is changed.

1. A URL management system comprising: a web site server containing the content of a web site, a URL management server that associates the URL of the web site with an intermediate URL corresponding thereto and a search server that associates information regarding the content of the web site with the intermediate URL.

2. A URL management system according to claim 1, wherein the search server sends out the intermediate URL in response to a request from a search based on the information, and the URL management server converts the access destination to the URL of the web site in response to an access request made using the intermediate URL.

3. A URL management system according to claim 1, wherein, in response to receiving notification of a change in the URL of the web site, the URL management server does not change the intermediate URL but rather associates the new URL of the web site with the intermediate URL.

4. A URL management system according to claim 2, wherein, in response to receiving notification of a change in the URL of the web site, the URL management server does not change the intermediate URL but rather associates the new URL of the web site with the intermediate URL.

5. A URL management server comprising: means of generating an intermediate URL corresponding to the URL of a stipulated web site upon receiving information regarding the content of the stipulated web site and the URL of the stipulated web site, means of storing the URL of the stipulated web site associated with the intermediate URL and means of sending out information regarding the content of the stipulated web site and the intermediate URL to the search server.

6. A URL management server according to claim 5, wherein the means of generating an intermediate URL generates the intermediate URL by replacing the portion that identifies the server name within the URL of the stipulated web site with the server name of the URL management server.

7. A URL management server comprising: a URL management table that associates the URLs of a plurality of web sites with a plurality of intermediate URLs, wherein, in response to an access request made using a stipulated intermediate URL, a lookup of the URL management table is performed and the URL of the corresponding web site is read out, and the access is performed using the web site URL thus read out.

8. A URL management server according to claim 7, wherein, in response to receiving notification of a change in the URLs of the plurality of web sites, the intermediate URL is not changed but rather the URL of the stipulated web site registered in the URL management table is updated.
